(19) United States
(12) Patent Application Publication
(10) Pub. No.: US 2008/0303612 A1
(43) Pub. Date: Dec. 11, 2008

(54) WAVEGUIDE STRUCTURE

(75) Inventors: Ruei Yuen Chen, Hsinchu (TW); Hongru Suchen, Hsinchu (TW)

Correspondence Address: CONNOLLY BOVE LODGE & HUTZ LLP, 1875 EYE STREET, N.W., SUITE 1100, WASHINGTON, DC, 20006, US

(73) Assignee: Microelectronics Technology Inc., Hsinchu (TW)

(21) Appl. No.: 11/852,627

(22) Filed: Sep. 10, 2007

(30) Foreign Application Priority Data
Jun. 7, 2007 (TW) 096209353

(51) Int. Cl. H01P 3/12

(52) U.S. Cl. 333/248

(57) ABSTRACT

A waveguide structure comprises a first waveguide portion, a second waveguide portion and a third waveguide portion. The first, second and third waveguide portions are connected in a series; signals feed into the first waveguide portion and then propagate through the first, second and third waveguide portions in sequence; and the cross sections of the first to third waveguide portions descend in size.

### BACKGROUND OF THE INVENTION

1. Field of the Invention

The present invention relates to a waveguide structure, particularly to a waveguide structure applied to signal transmissions of satellite earth stations.

2. Description of the Related Art

In a typical satellite communication system, the front-end of an earth receiving station often uses a waveguide filter to separate transmitted signals and received signals. The waveguide is capable of reducing transmitting and insertion loss so as to achieve the best transmitting power and receiving noise figure.

Referring to FIG. 1, a satellite antenna communication system 10 includes a demultiplexer 11, an attenuator 12, a first intermediate frequency (IF) amplifier 13, a first mixer 14, a first bandpass filter 15, a power amplifier 16, an oscillator 17, a multiplexer 19, a low noise amplifier 21, an image rejection filter 22, a second mixer 23, a receiving oscillator 24, a second bandpass filter 25, a second IF amplifier 26 and a waveguide 27. The first IF amplifier 13, first mixer 14, first bandpass filter 15, power amplifier 16 and waveguide 27 constitute a block of up-converter (BUC) 28, which is able to raise the frequency of input signals of the demultiplexer 11, for example from 0.95˜1.45 GHz to 14˜14.5 GHz. After passing through the multiplexer 19, the signals are transmitted to an antenna 20 for wireless transmission. The low noise amplifier 21, image rejection filter 22, second mixer 23, second bandpass filter 25 and second IF amplifier 26 constitute a low noise block-converter (LNB) 29, which is capable of reducing receiving signal frequency of the antenna 20. After passing through the demultiplexer 11, the signals are sent to houses for use.

Please refer to FIG. 2. Conventionally, the waveguide 27 receives feed-in signals from a circuit board through the input end 31 thereof, and outputs signals through the output end 32 thereof. The two ends of the waveguide 27 are substantially symmetric, and include a terminal portion 33, a connecting portion 34 and an intermediate portion 35. The terminal portion 33 has the largest cross section along the direction of signal transmissions, the connecting portion 34 has a medium-sized one, and the intermediate portion 35 has the smallest one. Because the size of the cross section is inversely proportional to resistance thereof, to reduce signal loss, it is necessary to gradually transmit signals.

Currently it is common practice to design a waveguide incorporated inside the mechanical housing of a transmitter so as to reduce cost. However, due to large scale at two ends and complicated mechanical parts, when using conventional symmetrical structures, it is not easy to make a mold opening action or to reduce the cost thereof. Besides, the volume of the waveguide is so large that the volume of the transmitter is thus hard to reduce.

### SUMMARY OF THE INVENTION

The present invention provides a waveguide structure which is applied to signal transmission of satellite earth stations. By simplifying the structure of the prior waveguide, the mold opening action becomes easy. And since the length of the waveguide is reduced, a part of the insertion loss can be avoided.

The waveguide structure according to one embodiment of the present invention comprises a first waveguide portion, a second waveguide portion and a third waveguide portion. The first, second and third waveguide portions are connected in a series; signals feed into the first waveguide portion and then propagate through the first, second and third waveguide portions in sequence; and the cross sections of the first to third waveguide portions descend in size.

Because the sizes of the first to third waveguide portions vary in a descending order, the molding can be made by only one tooling slide so as to reduce manufacturing cost. Besides, compared to prior symmetric structures, the present waveguide structure can reduce insertion loss due to the elimination of a segment of waveguide.

### BRIEF DESCRIPTION OF THE DRAWINGS

The invention will be described according to the appended drawings in which:

FIG. 1 shows a hint diagram of a prior art satellite antenna communication circuit;

FIG. 2 shows a hint diagram of a prior art waveguide;

FIGS. 3 and 4 show waveguide structures according to embodiments of the present invention; and

FIG. 5 shows a circuit board of the waveguide structure according to one embodiment of the present invention.

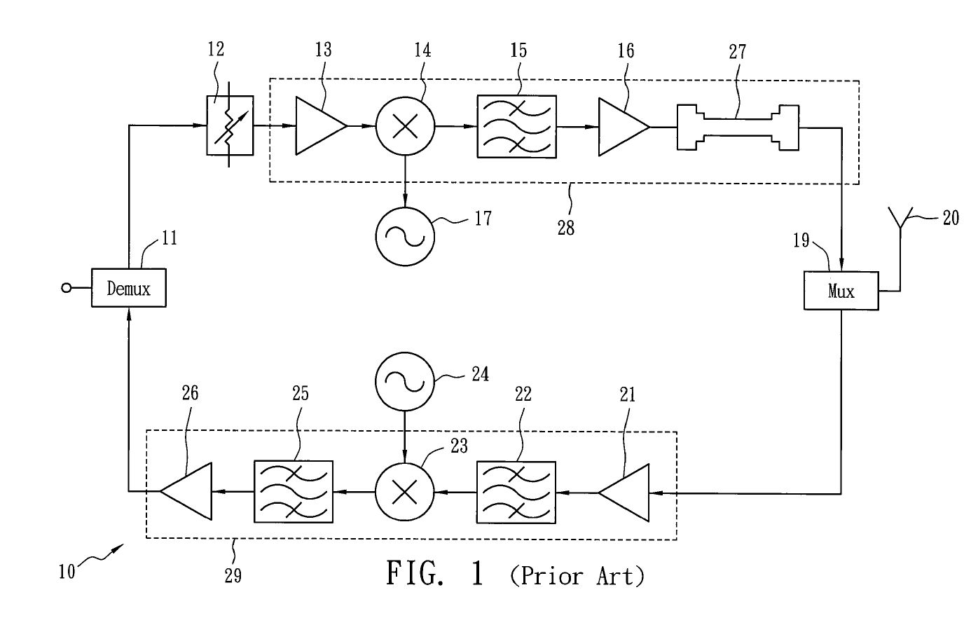

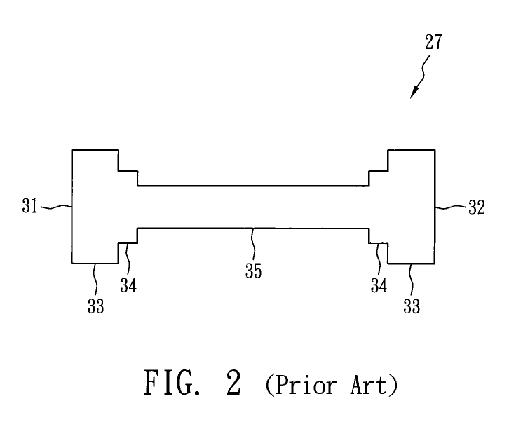

### PREFERRED EMBODIMENT OF THE PRESENT INVENTION

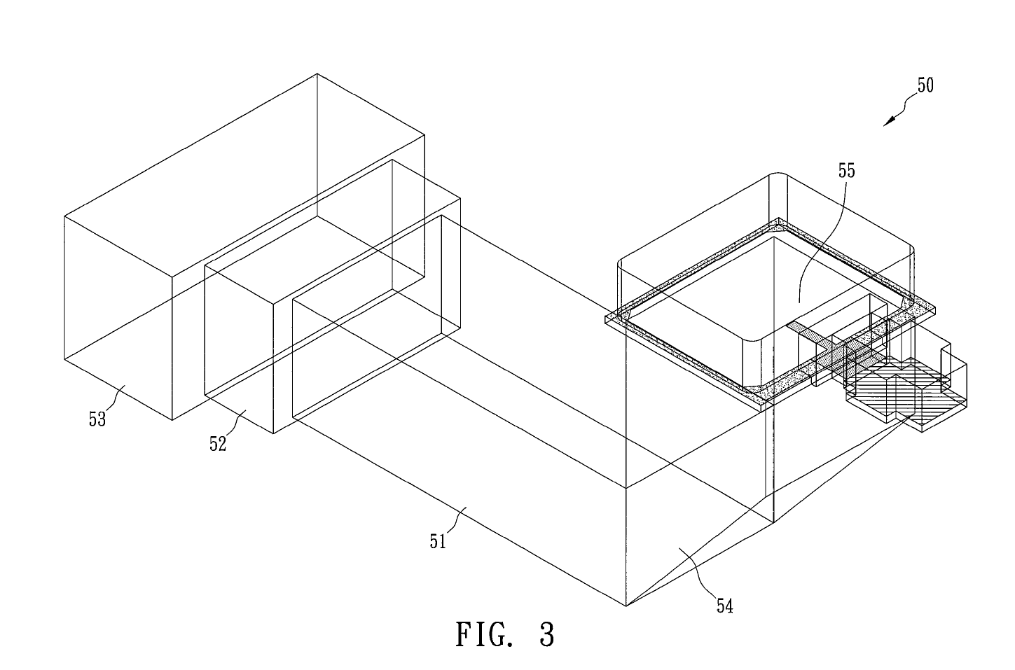

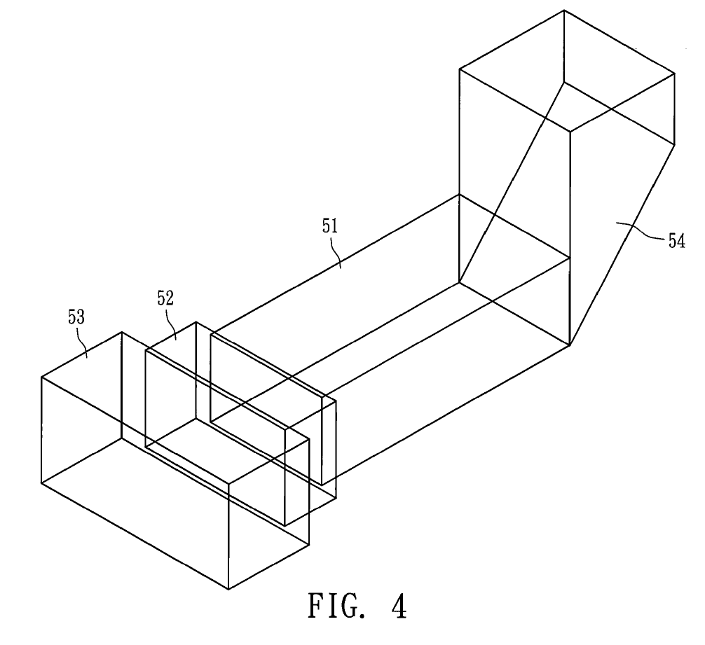

FIG. 3 shows waveguide structures according to embodiments of the present invention. A waveguide structure 50 includes a first waveguide portion 51, a second waveguide portion 52, a third waveguide portion 53, a connecting portion 54 and a circuit board 55. The signals which go through the circuit board 55 and the connecting portion 54 are fed into the first waveguide portion 51. Namely, one end of the first waveguide portion 51 serves as a feed-in point. Subsequently, the signals are forwarded to a multiplexer (not shown) through the second waveguide portion 52 and the third waveguide portion 53. The cross sections of the first, second and third waveguide portions 51-53 along the direction of signal transmissions are square-shaped. The connecting portion 54 is taper-shaped, with the top portion thereof connecting to the circuit board 55. FIG. 4 shows a solid view from another angle, and the first, second and third waveguide portions 51-53 and the connecting portion 54 are shown.

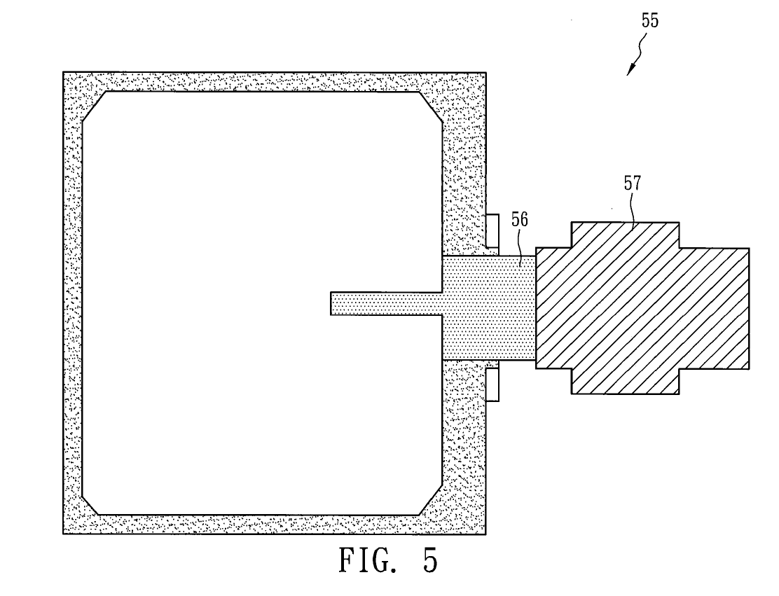

Referring to FIG. 5, the circuit board 55 includes a probe 56 and a low pass filter 57. The signals passing through the low pass filter 57, probe 56 and connecting portion 54 are fed into the first waveguide portion 51. The probe 56 and low pass filter 57 estimate the performance of signal transmission by simulation first, and later combine all components to do a more detailed simulation to ascertain the best geometric shape and scale.

The sizes of the first, second and third waveguide portions 51-53 vary in a descending order, therefore upon opening mold, the three components can all be made from one single material. Accordingly, the waveguide molding of the present invention is quite simple, which can largely reduce the cost. Besides, compared to prior symmetric structures, the present waveguide structure can eliminate a segment of the prior waveguide, and thus can reduce some receiving loss.

The above-described embodiments of the present invention are intended to be illustrative only. Numerous alternative embodiments may be devised by persons skilled in the art without departing from the scope of the following claims.

What is claimed is:

1. A waveguide structure comprising:
a first waveguide portion;
a second waveguide portion; and
a third waveguide portion;
wherein the first, second and third waveguide portions are connected in a series, signals feed into the first waveguide portion and then propagate through the first, second and third waveguide portions in sequence, and the cross sections of the first to third waveguide portions descend in size.

2. The waveguide structure of claim 1, wherein the cross section along the direction of signal transmissions is rectangle-shaped.

3. The waveguide structure of claim 1, further comprising a circuit board electrically connected to one end of the first waveguide portion for feeding the signals into the first waveguide portion.

4. The waveguide structure of claim 3, further comprising a connecting portion between the circuit board and the first waveguide portion.

5. The waveguide structure of claim 4, wherein the connecting portion is taper-shaped, and the circuit board is placed above the connecting portion.

6. The waveguide structure of claim 3, wherein the circuit board comprises a probe and a low pass filter.

7. The waveguide structure of claim 1, wherein the first, second and third waveguide portions are made by only one tooling slide.

8. The waveguide structure of claim 1, which is applied to signal transmissions of satellite earth stations.
